(19) United States
(12) Patent Application Publication
(10) Pub. No.: US 2006/0289469 A1
(43) Pub. Date: Dec. 28, 2006

(54) Flexible electrically conductive circuits

(75) Inventors: N. Satish Chandra, Lansdale, PA (US); William F. McNally, Clarks Summit, PA (US); Joel M. Furey, Stowe, VT (US); Anthony Michael Sosnowski, Stroudsburg, PA (US)

Correspondence Address: AKERMAN SENTERFITT, P.O. BOX 3188, WEST PALM BEACH, FL, 33402-3188, US

(73) Assignee: Noble Fiber Technologies LLC, Scranton, PA (US)

(21) Appl. No.: 11/409,243

(22) Filed: Apr. 21, 2006

Related U.S. Application Data
(60) Provisional application No. 60/673,709, filed on Apr. 21, 2005.

(51) Int. Cl. H05B 3/34; H05B 3/54

(52) U.S. Cl. 219/528

(57) ABSTRACT

A flexible electrical circuit formed from a flexible fabric of a nonconductive material that forms a sheet and one or more conductive circuits attached to the fabric and formed at least partially from silver. The conductive circuits may be formed from at least one conductive fiber formed from a core coated with a coating at least partially formed from silver, wherein the core is formed at least partially from nylon. In at least one embodiment, the outer coating may have a silver content of more than 95 percent. The fiber may be patterned stitched, plied multiple times, or attached in other manners to change the resistance. In another embodiment, the conductive circuits may be formed from an etched silver layer attached to the flexible fabric. The conductive circuits may be used in many applications, such as, but not limited to forming heaters, sensors, antennas, stretchable fabrics, and in other applications.

### CROSS-REFERENCE TO RELATED APPLICATIONS

This application claims the benefit of U.S. Provisional Application No. 60/673,709, filed Apr. 21, 2005.

### FIELD OF THE INVENTION

This invention is directed generally to flexible circuits, and more particularly to flexible circuit boards and related systems.

### BACKGROUND

Conventional circuit boards are typically formed from a rigid board that supports one or more electrical circuits. Such rigid circuit boards are typically used in electronic systems such as personal computers, cellular phones, televisions, and other devices. Conventional rigid circuits are often formed with multilayer printed circuit boards formed of glass cloth reinforced copper-clad plastic substrates. The substrates typically range in thickness from about 4-8 mils for the insulative plastic. The circuitry is typically etched into the glass cloth reinforced copper-clad plastic substrate. After etching, the inner layers of the board are laminated to form a multiple layer board formed of circuitry, a ground plane level and a power plane level. Holes are typically drilled through the board stack and walls of the holes are plated to form conductive interconnects between the multiple board layers. The process used to manufacture these boards has notable problems such as, drill wear and hole size limitations. In addition, the rigid boards are not useful in many applications where space is limited.

Flexible circuits have been made in an effort to overcome these limitations. Flexible circuits have been formed from flexible substrates having cover coats formed from non-photoimageable polyimide and polyester and other non-photoimageable cover coats, such as TEFLON and ultem. A drawback of these flexible circuits is that their utility is typically limited to specialized applications. A conventional fabrication method of the flexible circuit includes pre-punching the cover coats with holes for solder pads and then carefully aligning the cover coat on the base material. Industry needs call for more apertures in the cover coats. However, the current process cannot efficiently accommodate these changes without adding additional complexity and costs to the manufacturing process.

Moreover, flexible circuits typically include electrical conductors formed exclusively from copper foil. Such configurations are designed to bend only to a limited degree. In particular, such configurations are often capable of being bent in a circular configuration having a radius of curvature of about four inches. However, when the flexible circuits are folded in a smaller circle or folded into two planes that are parallel or nearly parallel to each other and in close proximity with each other, the copper foil breaks, thereby breaking the circuit and rendering the flexible circuit inoperable. Thus, a need exists for an alternative flexible circuit.

### SUMMARY OF THE INVENTION

This invention is directed to a flexible electrical circuit formed from a flexible fabric and one or more conductive circuits attached to the flexible fabrics and formed at least partially from silver or other appropriate metals. The flexible electrical circuit may be configured for use in many applications, such as, but not limited to forming heaters, sensors, antennas, stretchable fabrics, medical applications, printed circuit boards, personal digital assistants (PDAs), and in other applications.

The flexible fabric may be formed from any fabric such as, but not limited to, nylon, polyester, acrylic, rayon, other polymeric materials, and other materials. In one embodiment, the flexible fabric may form a sheet of material. The flexible fabric may be stretchable, such as by including SPANDEX or other stretchable fibers in the formation of the flexible fabric. The flexible fabric may be used to form garments, such as shirts, pants, and other garments for positioning conductive circuits in close proximity to an outer skin surface of a person wearing the garment. The flexible fabric may also be launderable such that the fabric may be cleaned using mechanical washing machines and cleaned in other appropriate manners.

The conductive circuit may be formed from one or more conductive fibers. The conductive fibers may be formed from a core coated with a coating at least partially formed from silver. In at least one embodiment, the coating may be formed by at least 95 percent silver. The silver may be applied to the core with conventional metallizing techniques, such as chemical deposition and other appropriate methods. The silver coated core may be X-STATIC, produced by Sauquoit Industries, Inc., Scranton, Pa., or other appropriate materials. The core may be formed from materials including, but not limited to, nylon and other appropriate materials. In other embodiments, other metals may be used.

The conductive fiber may be embroidered onto the flexible fabric formed from the nonconductive material. The conductive fiber may be patterned stitched, which is also referred to as repetitive stitched, to adjust the resistance of the conductive circuit. The conductive fiber may also be plied two or more times to adjust the resistance of the conductive circuit.

In another embodiment, the conductive circuit may be formed from an etched silver layer attached to the flexible fabric and formed at least partially from silver. The etched layer may be created by applying a resist, such as acrylic, onto the flexible fabric to attach the layer to the flexible fabric. The layer may then be etched to remove excess portions of the layer to form the conductive circuit.

The conductive circuit may be formed in any appropriate configuration. For instance, the conductive circuit may be formed in a serpentine configuration to create a heater, a generally helical shape to form a sensor, such as an electrocardiogram (EKG) sensor used together with an EKG system, or an antenna. The conductive circuit is not limited to these use but may be used in other application as well.

An advantage of this invention is that the flexible circuit may be formed from a flexible fabric that is launderable, thereby enabling the flexible circuit to be incorporated into garments and other items that are laundered.

Another advantage of this invention is that the flexible circuit is very flexible and may be folded without breaking the conductive circuit.

Yet another advantage of this invention is that the flexible circuit is cost effective and can be manufactured in large quantities efficiently.

Another advantage of this invention is that the conductive fibers may be woven, sewn, knit, embroidered or otherwise attached to the flexible fabric to form the flexible electrical circuit.

Still another advantage of this invention is that the flexible electrical circuit is lightweight, thereby making it useful in a variety of applications.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a top view of an embodiment of the invention in which a conductive circuit is attached to a flexible fabric.

FIG. 2 is a top view of another embodiment of this invention in which the flexible electrical circuit is formed into an antenna having a bow tie shape.

FIG. 3 is a top view of another embodiment of this invention in which the flexible electrical circuit is formed into an antenna having a dipole configuration.

FIG. 4 is a top view of an embodiment of a flexible electrical circuit having aspects of the invention.

FIG. 5 is a front view of a flexible electrical circuit of this invention attached to a garment.

FIG. 6 is a perspective view of an end of an exemplary conductive fiber used to form the flexible electrical circuit of the invention.

FIG. 7 is a perspective view of a sheet of material in which a conductive layer is attached to a flexible fabric during a manufacturing process used to form the flexible electrical circuit.

FIG. 8 is a table depicting resistance values for 100 xs 34 two-ply silver coated filaments that are patterned stitched in different stitches.

FIG. 9 is a table depicting resistance values for 100 xs 34 one-ply silver coated filaments that are patterned stitched in different stitches.

FIG. 10 is a top view of an embodiment of this invention in which a plurality of flexible electrical circuits are attached to a single flexible fabric during the manufacturing process.

FIG. 11 is a perspective view of the flexible electrical circuit of this invention in a folded position in which the flexible fabric resides in two planes that are in close proximity to each other and substantially parallel to each other.

### DETAILED DESCRIPTION OF THE INVENTION

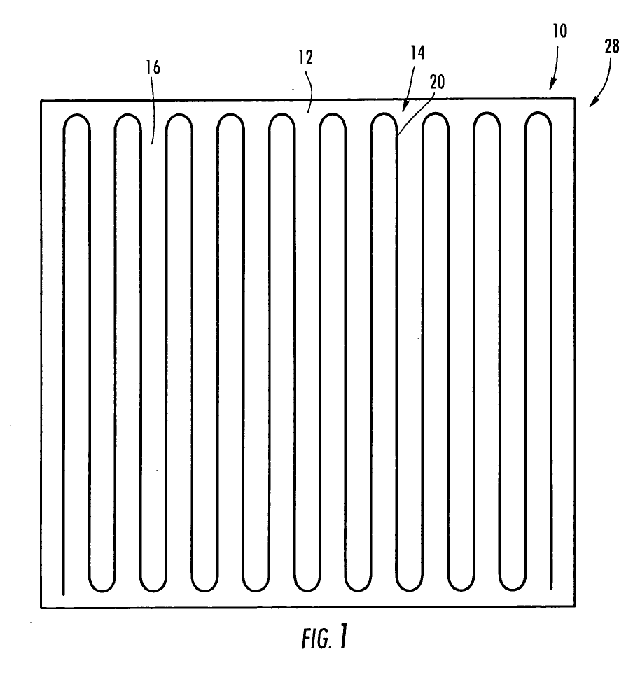

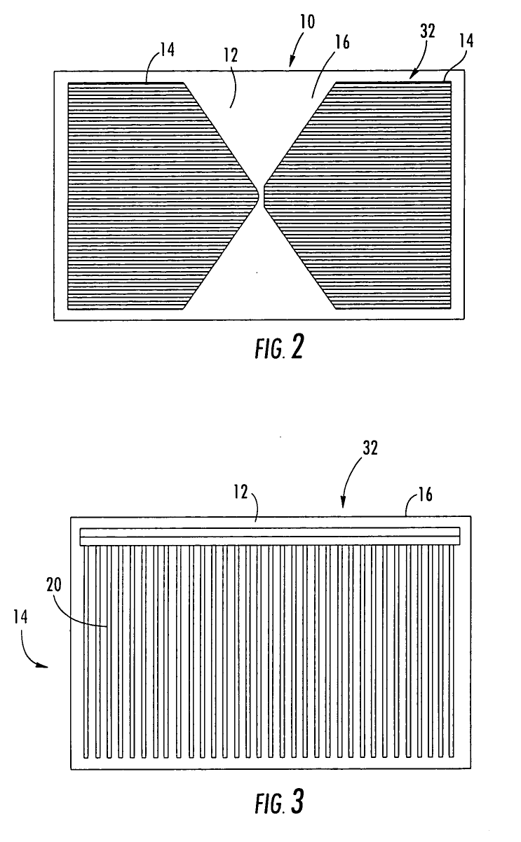

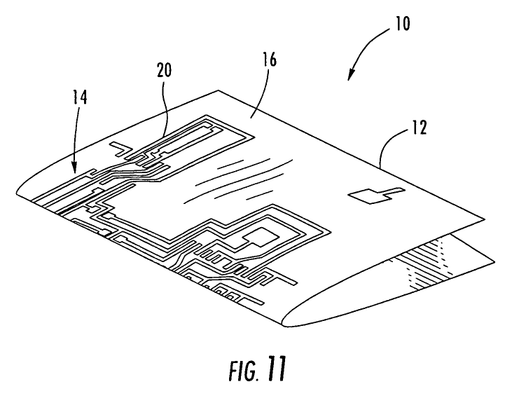

As shown in FIGS. 1-11, this invention is directed to a flexible electrical circuit 10 formed from a flexible fabric 12 and one or more conductive circuits 14 attached to the flexible fabrics 12 and formed at least partially from silver. The flexible electrical circuit 10 may be configured for use in many applications, such as, but not limited to forming heaters, as shown in FIG. 1, sensors 30, as show in FIG. 5, antennas, as shown in FIGS. 2 and 3, stretchable fabrics, and in other applications.

The flexible fabric 12 may be formed from any fabric. The fabric 12 may be, but is not limited to being, fabrics and filler materials formed from nylon, polyester, acrylic, rayon, other polymeric materials, and other materials. In one embodiment, the flexible fabric 12 may form a sheet 16 of material, as shown in FIGS. 1-5. The sheet 16 may reside in a single plane or may be manipulated to reside in multiple planes. The flexible fabric 12 may be folded or bent such that the fabric may reside in two planes that are in close proximity to each other and may contact each other, such as a folded shirt or other folded fabric 12. The flexible fabric 12 may be stretchable, such as by including SPANDEX or other stretchable fibers in the formation of the flexible fabric 12. The flexible fabric 12 may be used to form garments 18, as shown in FIG. 5, such as shirts, pants, and other garments 18 for positioning conductive circuits 14 in close proximity to an outer skin surface of a person wearing the garment 18. The flexible fabric 12 may also be launderable such that the fabric 12 may be cleaned using mechanical washing machines and cleaned in other appropriate manners.

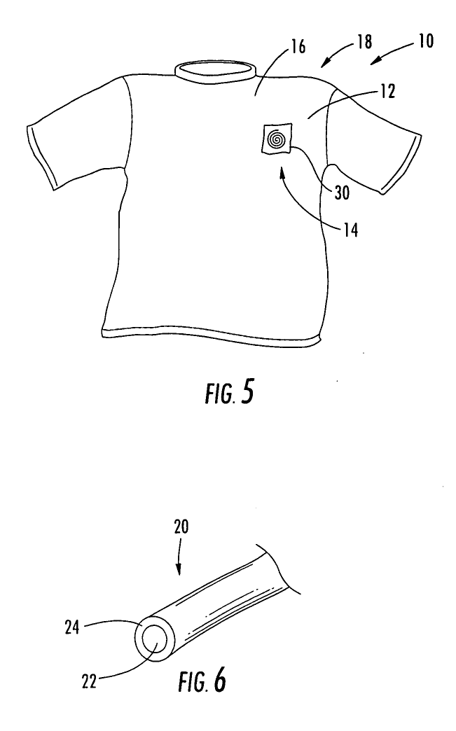

The conductive circuit 14 may be formed from one or more conductive fibers 20. The conductive fibers 20 may be formed from a core 22 coated with a coating 24 at least partially formed from silver, as shown in FIG. 6. In at least one embodiment, the coating 24 may be formed by at least 95 percent silver. The silver may be applied to the core 22 with conventional metallizing techniques, such as chemical deposition and other appropriate methods. The silver coated core 22 may be formed using the deposition process described in United States Published Patent Application US 2004/0173056 and in U.S. Pat. No. 4,042,737, both of which are herein incorporated by reference. In at least one embodiment, the core 22 may be a silver coated nylon filament, such as X-STATIC, produced by Sauquoit Industries, Inc., Scranton, Pa. The core 22 may be formed from materials including, but not limited to, nylon and other appropriate materials. In other embodiments, other metals may be used.

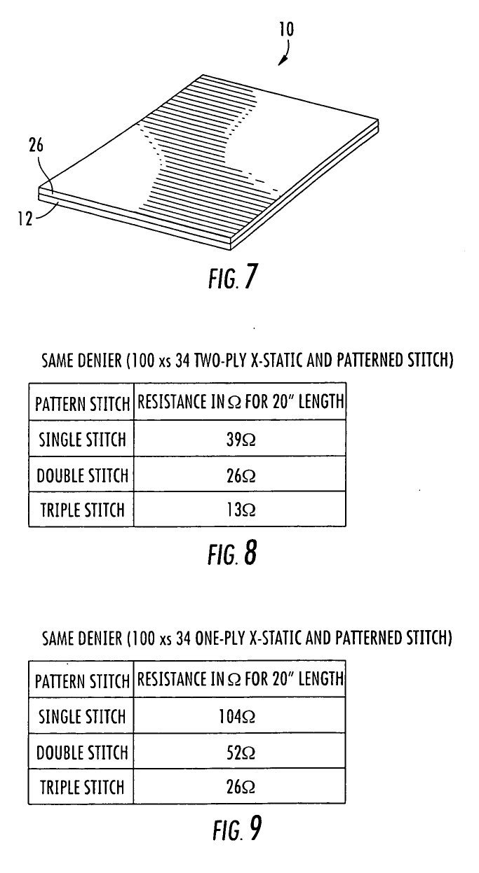

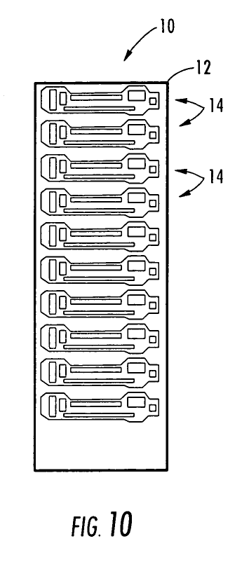

The conductive fiber 20 may be embroidered onto the flexible fabric 12 formed from the nonconductive material. The conductive fiber 20 may be patterned stitched, which is also referred to as repetitive stitched, to adjust the resistance of the conductive circuit 14. The conductive fiber 20 may also be plied two or more times to adjust the resistance of the conductive circuit 14. For instance, as shown in FIG. 8, the resistance may be varied by changing the stitch pattern for a conductive fiber 20 having the same denier, such as 100 xs two ply X-STATIC fiber. The resistance of the conductive fiber 20 having a twenty inch length may be 39 ohms for a single stitch pattern, 26 ohms for a double stitch pattern, and 13 ohms for a triple stitch pattern. As shown in FIG. 9, the resistance may be varied by changing the stitch pattern for a conductive fiber 20 having the same denier, such as 100 xs one ply X-STATIC fiber. The resistance of the conductive fiber 20 having a twenty inch length may be 104 ohms for a single stitch pattern, 52 ohms for a double stitch pattern, and 26 ohms for a triple stitch pattern.

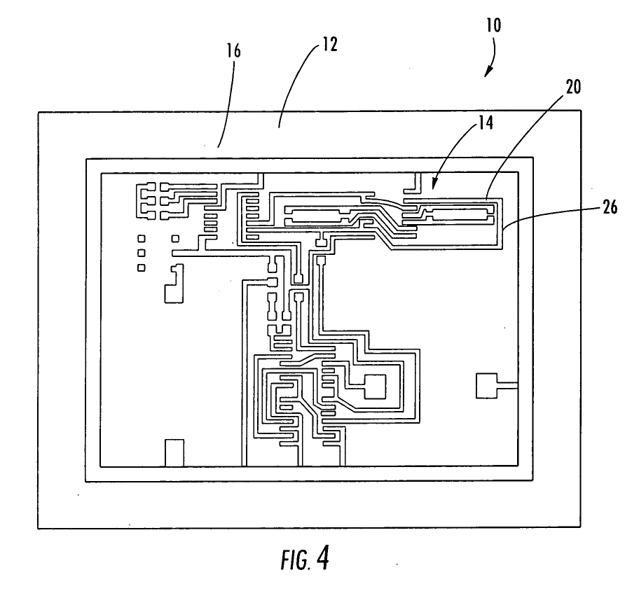

In another embodiment, as shown in FIGS. 4 and 7, the conductive circuit 14 may be formed from an etched silver layer 26 attached to the flexible fabric 12 and formed at least partially from silver. The etched layer 26 may be created by applying a resist, such as acrylic, onto the flexible fabric 12 to attach the layer 26 to the flexible fabric 12. The layer 26 may then be etched to remove excess portions of the layer 26 to form the conductive circuit 14. The layer 26 may be etched using an acidified ferrous nitrate spray or other appropriate material. The fabric 12 may then be washed to remove any lose metal, thereby leaving a conductive circuit 14 on the flexible fabric 12. The fabric 12 and layer 26 may be over plated using conventional electroplating to prevent portions of the layer 26 from inadvertently being removed from the fabric 12.

The conductive circuit 14 may be formed in any appropriate configuration. For instance, the conductive circuit 14 may be formed in a serpentine configuration, as shown in FIG. 1, for creating a heater 28. In another embodiment, as shown in FIG. 5, the conductive circuit 14 may have a generally helical shape forming a sensor 30. In at least one embodiment, the sensor 30 may be used as an electrocardiogram (EKG) sensor together with an EKG system. The sensor 30 may be freestanding or attached to a garment 18, such as a shirt, pant, or other garment.

As shown in FIGS. 2-3, the conductive fiber 20 may form an antenna 32. The antenna 32 may be formed into a bow-tie shape, as shown in FIG. 2, may be formed into a dipole configuration, as shown in FIG. 3, or may have another configuration. The antenna 32 may be formed by embroidering the conductive fibers 20 to the flexible fabric 12 or through another manner.

The flexible electric circuit 10 may be formed such that the fabric 12 may be folded, as shown in FIG. 11, without breaking the conductive circuit 14. Rather, the fabric may be folded, laundered in conventional washing machines without breaking the conductive circuit 14. The flexible electrical circuit 10 of this invention in a folded position in which the flexible fabric 12 resides in two planes that are in close proximity to each other and substantially parallel to each other. Thus, the flexible electric circuit 10 may be used in many applications.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

We claim:

1. A flexible electrical circuit circuit, comprising:
a flexible fabric formed from a nonconductive material and forming a sheet;
at least one conductive circuit attached to the fabric and formed at least partially from silver.

2. The flexible electrical circuit of claim 1, wherein the at least one conductive circuit is formed from at least one conductive fiber.

3. The flexible electrical circuit of claim 2, wherein the at least one conductive fiber is formed from a core coated with a coating at least partially formed from silver.

4. The flexible electrical circuit of claim 3, wherein the coating is formed from at least 95 percent silver.

5. The flexible electrical circuit of claim 3, wherein the core is formed from nylon.

6. The flexible electrical circuit of claim 2, wherein the at least one conductive fiber is embroidered onto the fabric formed from the nonconductive material.

7. The flexible electrical circuit of claim 6, wherein the at least one conductive fiber embroidered onto the fabric forms an antenna.

8. The flexible electrical circuit of claim 7, wherein the at least one conductive fiber embroidered onto the fabric forms an antenna formed into a bow-tie shape.

9. The flexible electrical circuit of claim 7, wherein the at least one conductive fiber embroidered onto the fabric forms an antenna formed into a dipole configuration.

10. The flexible electrical circuit of claim 2, wherein the at least one conductive fiber is patterned stitched to adjust the resistance of the at least one conductive circuit.

11. The flexible electrical circuit of claim 2, wherein the at least one conductive fiber is plied at least two times to adjust the resistance of the at least one conductive circuit.

12. The flexible electrical circuit of claim 1, wherein the at least one conductive circuit attached to the flexible fabric and formed at least partially from silver is formed from a layer attached to the flexible fabric, wherein the conductive circuit is etched into the layer forming the conductive circuit.

13. The flexible electrical circuit of claim 1, wherein the at least one conductive circuit is formed in a serpentine shape creating a heater.

14. The flexible electrical circuit of claim 1, wherein the at least one conductive circuit is formed in a helical configuration forming an EKG sensor.

15. The flexible electrical circuit of claim 14, wherein the flexible fabric formed from a nonconductive material and forming a sheet is formed into a shirt wearable by a person.

16. The flexible electrical circuit of claim 1, wherein the flexible fabric formed from a nonconductive material and forming a sheet is formed from a stretchable material.

17. The flexible electrical circuit of claim 1, wherein the flexible fabric formed from a nonconductive material and forming a sheet forms a sensor.

18. A flexible electrical circuit, comprising:
a flexible fabric formed from a nonconductive material and forming a sheet;
at least one conductive circuit attached to the fabric and formed at least partially from silver;
wherein the at least one conductive circuit is formed from at least one conductive fiber formed from a core coated with a coating at least partially formed from silver, wherein the core is formed at least partially from nylon.

19. The flexible electrical circuit of claim 18, wherein the coating is formed from at least 95 percent silver.

20. The flexible electrical circuit of claim 18, wherein the at least one conductive fiber is embroidered onto the fabric formed from the nonconductive material.

21. The flexible electrical circuit of claim 20, wherein the at least one conductive fiber embroidered onto the fabric forms an antenna.

22. The flexible electrical circuit of claim 18, wherein the at least one conductive fiber is patterned stitched to adjust the resistance of the at least one conductive circuit.

23. The flexible electrical circuit of claim 18, wherein the at least one conductive fiber is plied at least two times to adjust the resistance of the at least one conductive circuit.

24. A flexible electrical circuit, comprising:
a flexible fabric formed from a nonconductive material and forming a sheet;
at least one conductive circuit formed from an etched silver layer attached to the flexible fabric and formed at least partially from a silver.
